(19) United States
(12) Patent Application Publication
(10) Pub. No.: US 2018/0162633 A1
(43) Pub. Date: Jun. 14, 2018

(54) CONTAINER ASSEMBLY FOR HEAT SENSITIVE MATERIAL

(71) Applicant: Mead Johnson Nutrition Company, Glenview, IL (US)

(72) Inventor: Margo E. Love, Evansville, IN (US)

(21) Appl. No.: 15/373,801

(22) Filed: Dec. 9, 2016

(51) Int. Cl. B65D 85/72; B65D 43/16; B65D 47/08; B65D 75/58; B65D 51/28; B65D 51/24; B65B 11/00; B65B 7/28; B65D 75/00; A23L 33/00

(52) U.S. Cl. CPC B65D 85/72; B65D 43/16; B65D 47/0857; B65D 75/5894; B65D 51/28; A23V 2002/00; B65B 11/00; B65B 7/28; B65D 75/002; A23L 33/40; B65D 51/245

(57) ABSTRACT

A container assembly includes a main container having an opening. A cap closes the opening. An externally open recess on the main container or the cap receives a tub. Removable packaging is disposed around the container assembly such that the tub is retained in the recess. The main container may include a liquid nutritional composition. The tub may include a heat sensitive material, such as a probiotic or lactoferrin for addition to the main container by a user.

### TECHNICAL FIELD

The present disclosure relates to a container assembly with a main container and a tub. More specifically, the disclosure is directed to a main container that includes a nutritional composition and a separate tub that is received in the main container. The tub has a heat sensitive material that can be added by a user to the main container before use of the nutritional composition. The disclosure also relates to a method of manufacturing a container assembly.

### BACKGROUND

Nutritional compositions, such as infant formulas, are most often heat sterilized to reduce the number of, or eliminate, potentially harmful microbes and particles. However, heat sterilization can render heat sensitive materials, such as probiotics or lactoferrin, nonfunctional or biologically inactive. While attempts have been previously made to provide heat sensitive materials separately from nutritional compositions, such as in U.S. Pat. Pub. No. 8,109,385 B2, further improvement is needed.

### BRIEF SUMMARY

In one embodiment, a container assembly includes a main container having an opening and a cap closing the opening. The main container, or the cap, has an externally open recess thereon. The recess may be positioned on a surface of the container or a top surface of the cap. In an embodiment having the recess on the top surface of the cap, the recess may be defined by a circular sidewall extending around the top surface of the cap. A tub is disposed at least partially in the recess. The recess may have a solid surface disposed against the tub. A removable packaging, such as shrink wrap, is disposed around the container assembly such that the removable packaging retains the tub in the recess. The main container may be heat treated prior to the addition of the tub having the heat sensitive material.

In another embodiment, the main container includes a main container chamber, and the tub has a tub chamber. The main container chamber contains a liquid nutritional composition, such as infant formula, and the tub chamber contains a heat sensitive material. The heat sensitive material may be lactoferrin, a probiotic, or a combination thereof. The tub chamber may be closed by a removable closure.

In an embodiment, a container assembly includes a main container having an opening, a cap closing the opening, and a top tub. The cap has a cap sidewall that defines an exterior recess, and the tub is disposed at least partially in the recess. The top tub includes a chamber and a tub closure removably sealing the chamber. The top tub may have an aesthetically pleasing profile, such as a heart-shaped profile, a circular profile, a star-shaped profile, a triangular profile, a reuleaux triangle-shaped profile, a crescent moon-shaped profile, a rectangular profile, or a square-shaped profile. The cap may be constructed of an opaque polymer and the top tub may be constructed of a clear or translucent polymer.

The cap sidewall has a cap sidewall height and the top tub has a top tub height. In one embodiment, the top tub height is greater than the sidewall height. The top tub may have a tub sidewall defining an opening. A sealing flange may extend outwardly around the opening from the top sidewall. The sealing flange may have an aperture.

In another embodiment, a method for manufacturing a container assembly includes providing a main container including an opening; attaching a closure to the main container, wherein the closure or the main container include an externally open recess; loosely disposing a tub in the recess; and securing the tub in the recess with packaging. The main container may be provided with a liquid nutritional composition, and the tub may be provided with a heat sensitive material. The securing step may comprise wrapping the tub with a heat-shrinkable polymer film.

One object of the invention is to provide a nutritional composition in a container assembly and a separately stored heat sensitive material that is combined in the assembly after the nutritional composition is heat treated.

Another object of the invention is that the container assembly should be user-friendly for the end user (i.e., consumer). A user-friendly container is one that is convenient for the ultimate user to store, use and combine the heat sensitive material with the nutritional composition prior to administration to a subject, such as a child. A user-friendly container also should minimize the risk of contamination or leaching of the container components into the product and providing a consumption risk to an end user.

A further object of the invention is that the container assembly should also be able to be produced using, and compatible with, modern container designs, manufacturing process, and materials.

Yet another object of the invention is to provide a user with a convenient means for adding a heat sensitive material to a heat treated nutritional composition prior to use.

An object of the invention is to provide a long shelf life for heat sensitive materials.

### BRIEF DESCRIPTION OF THE DRAWINGS

FIG. 1 is an elevation view of a cross-section of an embodiment of a container assembly.

FIG. 2 is an elevation view of a cross-section of another embodiment of a container assembly.

FIG. 3 is an elevation view of yet another embodiment of a container assembly.

FIG. 4A is a perspective view of an embodiment of a container assembly having a hinged lid, wherein the hinged lid is in a closed position.

FIG. 4B is a perspective view of an embodiment of a container assembly having a hinged lid, wherein the hinged lid is in an open position.

FIG. 5A is a perspective view of an embodiment of a container assembly having a screw top cap, wherein the screw top cap is on.

FIG. 5B is a perspective view of an embodiment of a container assembly having a screw top cap, wherein the screw top cap is off, and not shown.

FIGS. 6a-6e are perspective views of various embodiments of tubs.

FIG. 7 is an elevation view of an embodiment of a tub of FIG. 6e.

FIG. 8 is a top view of the tub 12 of FIG. 6e.

### DETAILED DESCRIPTION

Reference now will be made in detail to the embodiments of the present disclosure. It will be apparent to those of ordinary skill in the art that various modifications and variations can be made to the teachings of the present disclosure without departing from the scope of the disclosure. For instance, features illustrated or described as part of one embodiment, can be used with another embodiment to yield a further embodiment.

Thus, it is intended that the present disclosure covers such modifications and variations as come within the scope of the appended claims and their equivalents. Other objects, features and aspects of the present disclosure are disclosed in or are apparent from the following detailed description. It is to be understood by one of ordinary skill in the art that the present disclosure is a description of exemplary embodiments only and is not intended as limiting the broader aspects of the present disclosure.

For the sake of clarity, not all reference numerals are necessarily present in each drawing figure. In addition, positional terms such as “upper,” “lower,” “side,” “top,” “bottom,” “vertical,” “horizontal,” etc. refer to the container when in the orientation shown in the drawings. The skilled artisan will recognize that containers can assume different orientations when in use.

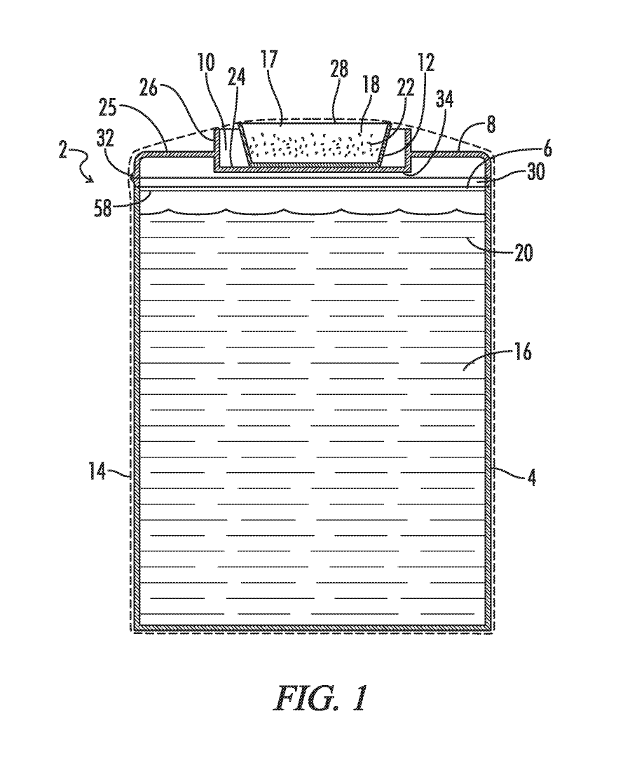

### Embodiment of FIG. 1

An elevation view of a cross-section of an embodiment of a container assembly 2 is shown in FIG. 1. Container assembly 2 includes a main container 4. Main container 4 may be constructed of, for example, polyethylene terephthalate, high density polyethylene, low density polyethylene, polypropylene, polystyrene, aluminum, steel, tin, or combinations thereof. In embodiments where main container 4 is constructed of steel, a plating of tin may be disposed on the steel to prevent rusting. Main container 4 may be constructed of an opaque polymer such that a user cannot externally view the contents of main container 4.

Container 4 includes a main container opening 6 and main container chamber 16. Opening 6 may be positioned at the top of main container 4 to enable removal of chamber 16 contents. Main container chamber 16 may contain a nutritional composition 20, such as infant formula, follow-on formula, a baby food formula, an infant cereals formula or a growing-up milk, infant or child food supplement or a starter infant formula. In an embodiment, nutritional composition 20 is in liquid form. Liquid nutritional composition 20 may be aseptic or heat treated. Nutritional composition 20 may lack, or be substantially free of, heat sensitive materials. “Substantially free” means at least 99% free by weight, preferably 99.9% free by weight, most preferably 99.99% by weight. Nutritional composition 20 may be lacking, or substantially free of heat sensitive materials such as probiotics, lactoferrin, vitamins A, E, C, B1, B6, folic acid, and heat sensitive lipids. Suitable probiotic bacteria include Lactobacillus rhamnosus GG, Lactobacillus reuteri, Lactobacillus fermentum, Lactobacillus johnsonii, Lactobacillus helveticus, Bifidobacterium breve, Bifidobacterium longum.

In certain embodiments, nutritional composition 20 may lack, or be substantially free of, ingredients that are heat stable but that would cause a shortening of the useful shelf life if included in the composition 20. Such shelf life-shortening ingredients include, but are not limited to, iron, zinc, copper, calcium, and magnesium. Omitting of iron from the liquid portion of the main container 4 slows the oxidation of lipids present therein, which is the limiting factor in shelf life of some nutritional compositions. The omission of iron also allows for a whiter appearance of the composition 20 by two mechanisms: the iron itself contributes to a darkening of the composition 20, and iron can promote the Maillard reaction, which leads to darkening. Further, in certain embodiments, it may be preferred to add iron in its ferrous state (+2), to increase bioavailability. This state can be maintained for a longer period in granular form separate from the nutritional composition 20 in the main container 4. Similarly, in certain embodiments, the nutritional composition 20 may lack, or be substantially free of, zinc and/or copper. Zinc and copper promote oxidation of ingredients such as lipids and vitamins present in the nutritional composition 20. Accordingly, omitting zinc and/or copper from the nutritional composition 20 may extend shelf life.

In certain embodiments, the nutritional composition 20 may lack, or be substantially free of, calcium and/or magnesium. Calcium and magnesium can promote protein aggregation during heating of the nutritional composition 20. Accordingly, omission of these ingredients can lead to a smoother liquid. In certain embodiments, the nutritional composition lacks, or is substantially free of, one or more vitamins. Certain vitamins such as vitamin C, vitamin D, vitamin K, vitamin B1, vitamin B2, and vitamin B6 are more stable in powdered form than in liquid form. Accordingly, it may extend shelf life to separately store such vitamins in powdered form.

In the context of nutritional compositions, product lipids, vitamins and probiotics, or beneficial bacteria which are often included in nutritional compositions, are especially prone to heat treatment damage. By adding heat sensitive material 22 with tub 12 after nutritional composition 20 has been heat treated with main container 4, the functional lifetime of heat sensitive material 22 is drastically improved. Moreover, by separately storing heat sensitive material 22 in granular form and nutritional composition 20 in liquid form, deterioration and damage, such as oxidative damage, to heat sensitive material 22 is reduced, also extending its shelf life. Long and stable shelf life is particularly important where circumstances preclude refrigeration, and further where container assembly 2 may be exposed to various environments, especially those associated with tropical climates. Ideally, a container assembly 2 should have a long shelf life under high temperatures during distribution and storage (e.g., temperatures of at least about 30° C., and up to and above 40° C.).

A cap 8 may be disposed over opening 6 to seal opening 6 and main container chamber 16. While it is noted that the following containers and caps are for dry materials, examples of construction of containers and caps that may be utilized in the practice of the present disclosure include US Pub. Nos. US 20160000270 A1, US 20150210444 A1 and US 20150197381 A1, which are hereby incorporated by reference in their entireties. Cap 8 may be operably connected to main container 4 by a collar 30. Cap 8 may be operably connected to collar 30 by, for example, a hinge 32, such as a living hinge 32. Collar 30 may be configured to snap fit to main container 4. Cap 8 and collar 30 may be integrally formed. Opening 6 may be sealed by a removable seal 58, such as a peelable seal 58, disposed below cap 8.

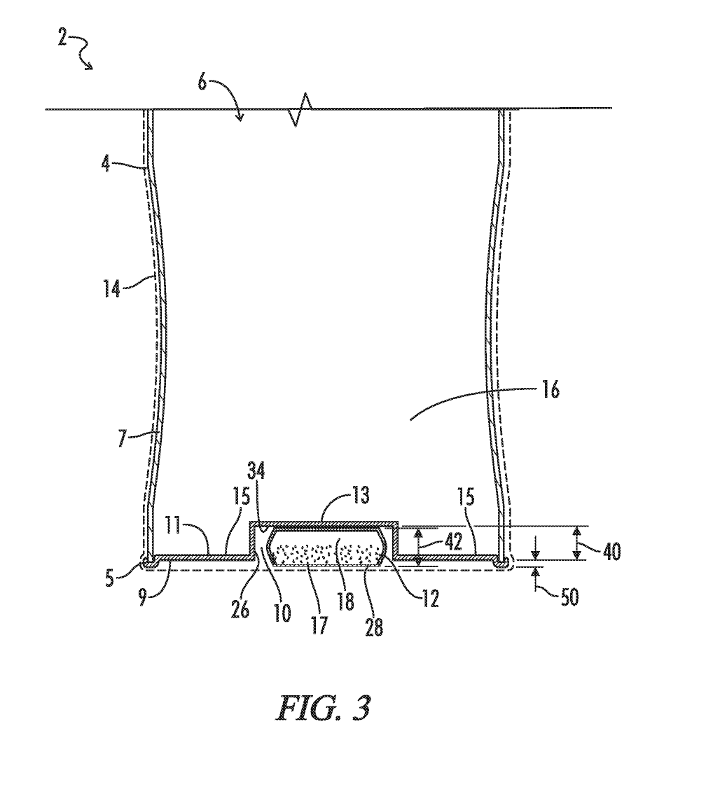

Container assembly 2 includes an externally open recess 10. Externally open recess 10 may be positioned on cap 8 or main container 4 (shown in FIG. 3). Externally open recess 10 may be positioned such that it is centered on cap 8. Externally open recess 10 may have a profile that is round, square, rectangular, oval, or trapezoidal. Externally open recess 10 is configured to receive a tub 12, also referred to herein as a top tub.

Tub 12 is disposed at least partially in recess 10. Tub 12 may be constructed of polyethylene terephthalate, high density polyethylene, low density polyethylene, polypropylene, polystyrene, aluminum, steel, polymeric resins, or combinations thereof. In an embodiment, tub 12 is constructed of a clear or a translucent polymer such that a user can externally view the contents of tub 12. Tub 12 includes a tub chamber 18. Tub chamber 18 may include heat sensitive material 22, such as probiotics, lactoferrin, vitamins A, E, C, B1, B6, and folic acid. In an embodiment, heat sensitive material 22 is also moisture sensitive. Heat sensitive material 22 may be in granular form. Heat sensitive material 22 may be added to nutritional composition 20 by a user, such as an end consumer. Heat sensitive material 22 may be added prior to first administration of nutritional composition 20 to an intended recipient, such as a human infant. Advantageously, by separating and separately storing heat sensitive material 22, the shelf life of the heat sensitive material can be significantly lengthened as compared to if heat sensitive material 22 was stored combined with nutritional composition 20. As discussed later, separating heat sensitive material 22 and nutritional composition 20 also brings further manufacturing advantages. Heat sensitive material 22 may be provided in tub 12 and not subjected to high heat treatment. For example, heat sensitive material 22 may not have been heat treated to a temperature of above 120 degrees C., 100 degrees, C 80 degrees C., or 60 degrees C. In an embodiment, heat sensitive material 22 is not subjected to any heat treatment. Tub 12 may also comprise heat stable ingredients that would cause a shortening of the useful shelf life of composition 20.

Tub 12 may be positioned on a top surface 24 of cap 8. Cap 8 also includes a top cap surface 25, and top surface 24 may be recessed below top cap surface 25. Advantageously, when top surface 24 is recessed below top cap surface 25, container assembly 2 has a compact height and may be more efficiently stored and shipped. Tub 12 may be loosely disposed on top surface 24 and/or loosely received in recess 10. By being loosely disposed on top surface 24 and/or received in the recess 10, a user can conveniently access tub 12 from recess 10. Tub 12 includes tub opening 17 for allowing a user to access heat sensitive material 22 in tub chamber 18. Tub opening 17 may be sealed by a removable seal 28, such as a peelable seal 28.

A sidewall 26 may be disposed around tub 12. Sidewall 26 may have, for example, a profile that is circular round, square, rectangular, oval, or trapezoidal. The profile of sidewall 26 may match the profile of tub 12.

A removable packaging 14 may be disposed around container assembly 2. Removable packaging 14 may be a polymer plastic film that can be applied over and shrinks tightly over container assembly 2, such as when heat is applied. Removable packaging 14 may be constructed of, for example, a polymer such as polyolefin, polyethylene, polypropylene. Removable packaging 14 may be coextrusions or laminations and be provided in layers. For example, a five layer configuration may be ethylene propylene/ethylene-vinyl acetate copolymer/copolyester/ethylene-vinyl acetate copolymer/ethylene propylene. Removable packaging 14 may be clear, translucent, or opaque. Advantageously, opaque removable packaging 14 may protect container assembly 2 and its contents from ultraviolet light damage.

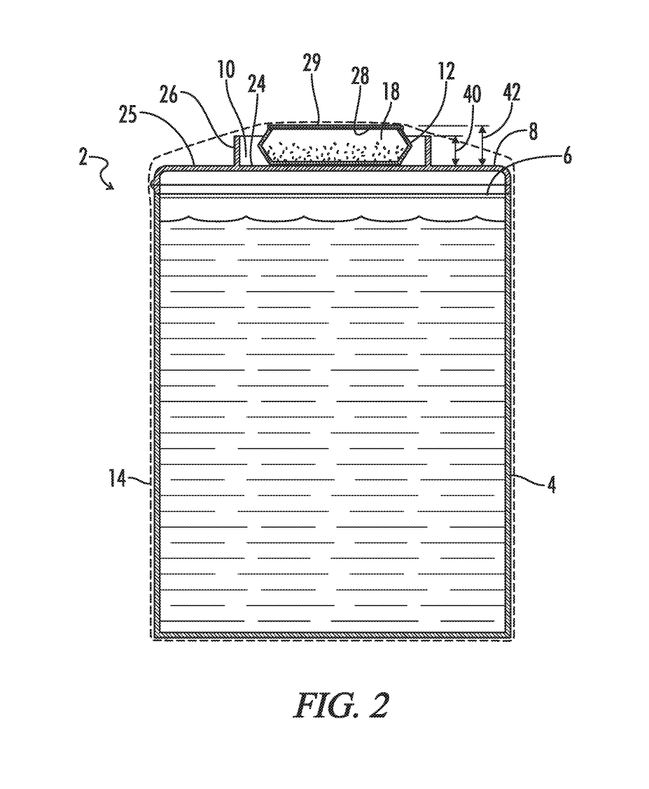

### Embodiment of FIG. 2

FIG. 2 shows an elevation, cross-sectional view of another embodiment of container assembly 2. Container assembly 2 includes main container 4 having main container opening 6. Cap 8 covers main container opening 6 and has a top cap surface 24 and a top surface 25. Tub 12 is disposed on top cap surface 24. Top cap surface 24 and top surface 25 may be at the same height. Cap 8 has externally open recess 10 defined by sidewall 26.

Sidewall 26 may have a sidewall height 40. Tub 12 may have a tub height 42. Sidewall height 40 may be less than tub height 42. For example, sidewall height 40 may be from 60-90%, 70-80%, or about 75% of tub height 42. Advantageously, the varied heights of sidewall height 40 and tub height 42 allow for removable packaging 14 to secure tub 12 by applying inward pressure. Tub 12 may also be sealed by a removable closure 29 for sealing tub chamber 18. Removable closure 29 may snap fit to tub 12 and be disposed over seal 28.

### Embodiment of FIG. 3

FIG. 3 is an elevation view of yet another embodiment of a container assembly 2. Main container 4 may have a pillar-shaped profile with a continuously curved sidewall 7 with main container opening 6 at its top. A bottom 9 of main container 4 may have a rolled edge 5 at the junction where sidewall 7 and bottom 9 meet. Rolled edge 5 may have a rolled edge height 50. Bottom 9 may have externally open recess 10, defined by sidewall 26, disposed therein. Recess 10 may project into main container chamber 16. Main container 2 may have a chamber bottom 11 surface. Chamber bottom 11 may be stepped, as shown, such a recessed portion 13 is higher than surrounding portions 15 of chamber bottom 11. Chamber bottom 11 may also be continually and gradually curved (not shown) such that recess 10 is less visible to a user looking into main container chamber 16. A benefit of the continuous and gradually curved chamber bottom 11 is better access to nutritional composition 20 from chamber 16.

In an embodiment, puck-shaped tub 12 having tub chamber 18 is disposed in recess 10. Tub 12 has tub opening 17. Tub 12 may have a tub height 42 that is less than sidewall height 40 and rolled edge height 50 combined. Advantageously, tub height 42 that is less than sidewall height 40 and rolled edge height 50 combined allows for main container 4 to rest securely on a surface, such as a surface of a table.

Removable packaging 14 may secure tub 12 in recess 10. Tub 12 may have a removable seal 28. Seal 28 may be positioned against removable packaging 14 or a bottom surface 34 of container bottom 9. Bottom surface 34 may be solid. Seal 28 may be a heat seal or a sonic seal.

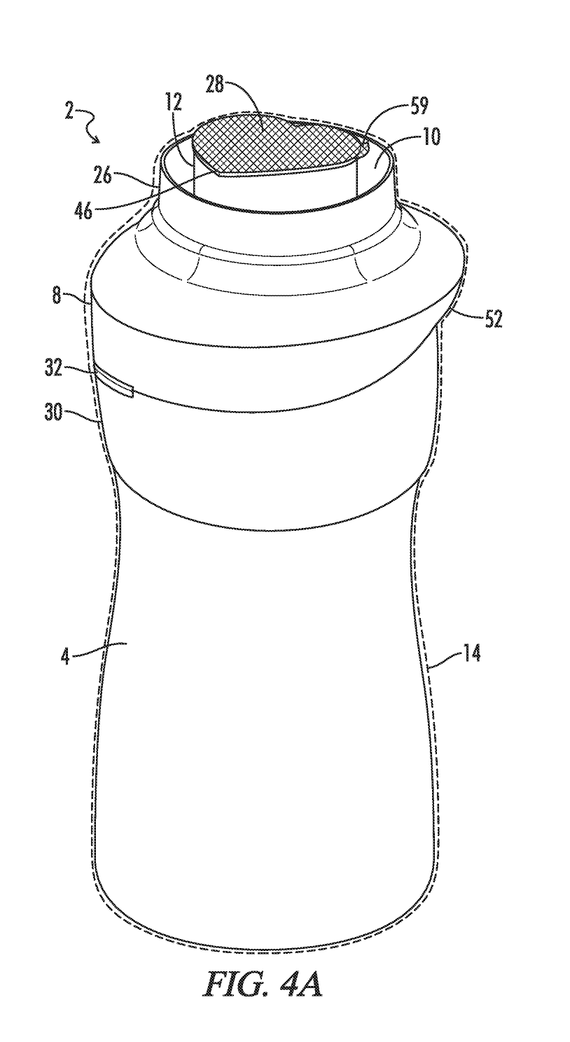

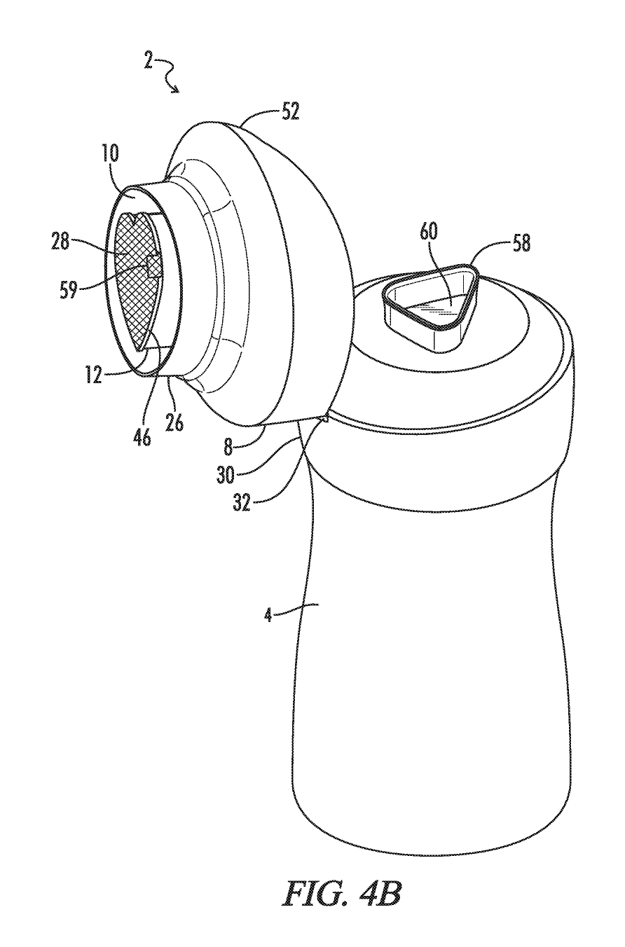

### Embodiments of FIGS. 4 and 5

FIGS. 4 and 4b are perspective views of an embodiment of a container assembly 2. Container assembly 2 has pillar-shaped main container 4 operably connected to collar 30. Collar 30 seals main container 4. Collar 30 can be placed atop any type of container closure. FIGS. 4 and 5 show two exemplary closures.

In certain embodiments, as shown in FIG. 4A, collar 30 is hingedly attached to cap 8 via hinge 32. Cap 8 may have a tapered end 52 opposite from hinge 32. Advantageously, tapered end 52 may, for example, provide a user with an ergonomically means for hingedly operating cap 8 and engaging and disengaging cap 8 with collar 30. FIG. 4A shows collar 30 and cap 8 in a closed position. FIG. 4B shows collar 30 and cap 8 in an open position. As shown in FIG. 4B, opening cap 8 exposes a pour spout 58, from which the contents of main container 4 can be dispensed.

Cap 8 may have sidewall 26 rising upwardly from cap 8. Sidewall 26 may define an externally open recess 10, in which tub 12 may be disposed. In one embodiment, not shown, tub 12 is configured to engage with cap 8. Tub 12 may comprise removable seal 28, optionally comprising a pull tab 59. Shrink wrap film 14 may hold tub 12 in place on cap 8. Also, cap 8 may be separately heat-sealed to secure tub 12 into recess 10.

In certain embodiments, as shown in FIG. 5A, cap 8 can be a screw-top type cap. FIG. 5A shows container assembly 2 in a closed position. FIG. 5B shows container assembly 2 in an open position (with cap not shown). As shown in FIG. 5B, opening cap 8 exposes a pour spout 60, from which the contents of main container 4 can be dispensed. Pour spout 60 may be covered by a removable seal (e.g., a seal comprising foil or plastic) as shown in FIG. 5B.

### Tub Shapes

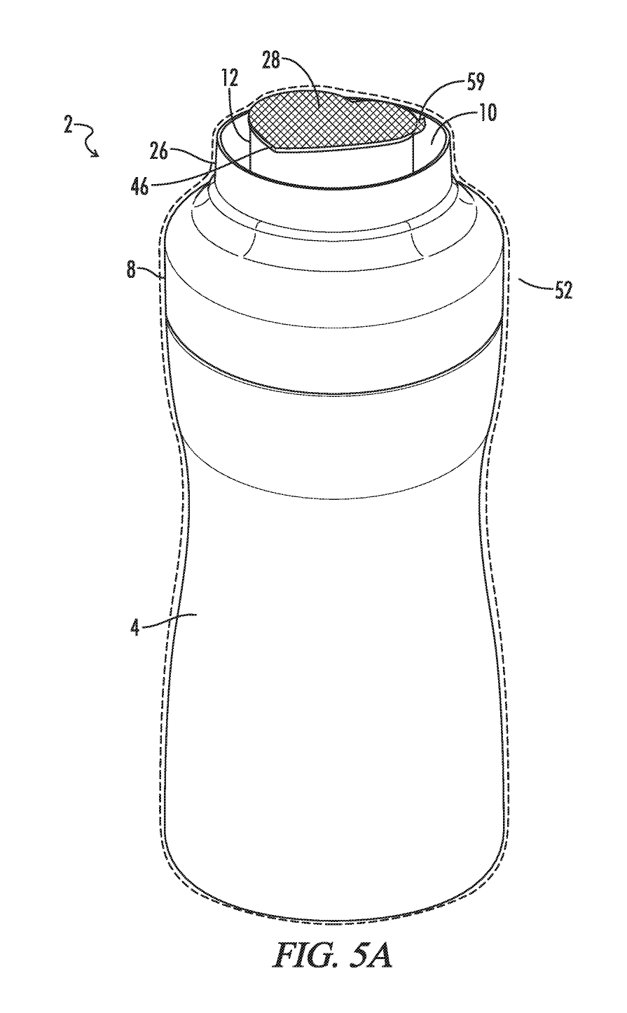

FIGS. 6A-6E are perspective views of various embodiments of tub 12. Tub 12 may have a variety of profiles. For example, in FIG. 6A, tub 12 has a heart-shaped profile; in FIG. 6B, a star-shaped profile; in FIG. 6C, a triangle-shaped profile; in FIG. 6D, a crescent moon-shaped profile; in FIG. 6E, a square-shaped profile. Tub 12 has tub sidewall 44 extending around tub opening 17. A sealing flange 46 may extend outwardly from the top of sidewall 44. Sealing flange 46 may be flat and disposed around the top of sidewall 44 such as to secure seal 28. Sealing flange 46 may have an aperture 48 disposed therein. Aperture 48 may be used to hang tub 12. For example, a user may hang multiple tubs 12 on a ring for convenient storage. Aperture 48 may also be used for configuring tub 12 as a charm.

Tub 12 may be configured to be dual function. In addition to storing a heat sensitive material 22, tub 12 may be configured for an additional purpose. Tub 12 may, for example, be configured to be a mold for moldable clay or a modeling compound, such as mixtures of flour, water, salt, boric acid and mineral oil. Thus, not only are the variety of tub 12 shapes aesthetically appealing to a user, they also provide users with various shapes for molding. In another embodiment, tub 12 may be configured to be a toy, a collectible, a charm, or a combination thereof.

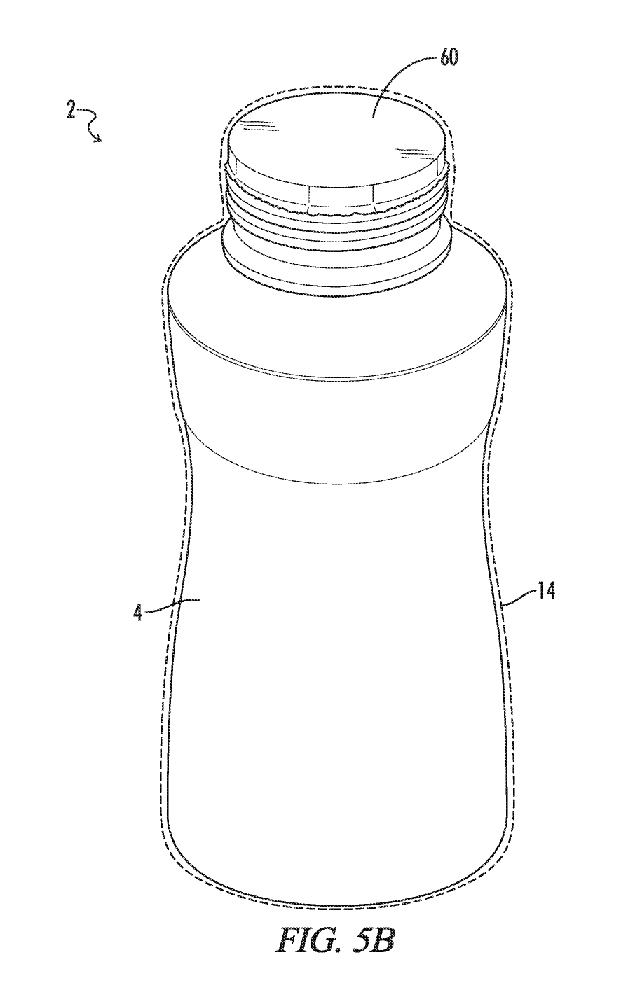

FIG. 7 is an elevation view of the tub 12 of FIG. 6E. Tub 12 has sealing flange 46 extending outwardly from tub sidewall 44. Tub sidewall 44 may have a flat edge 54. Advantageously, flat edge provides a sealing surface for seal 28. Tub 12 has a tub height 42.

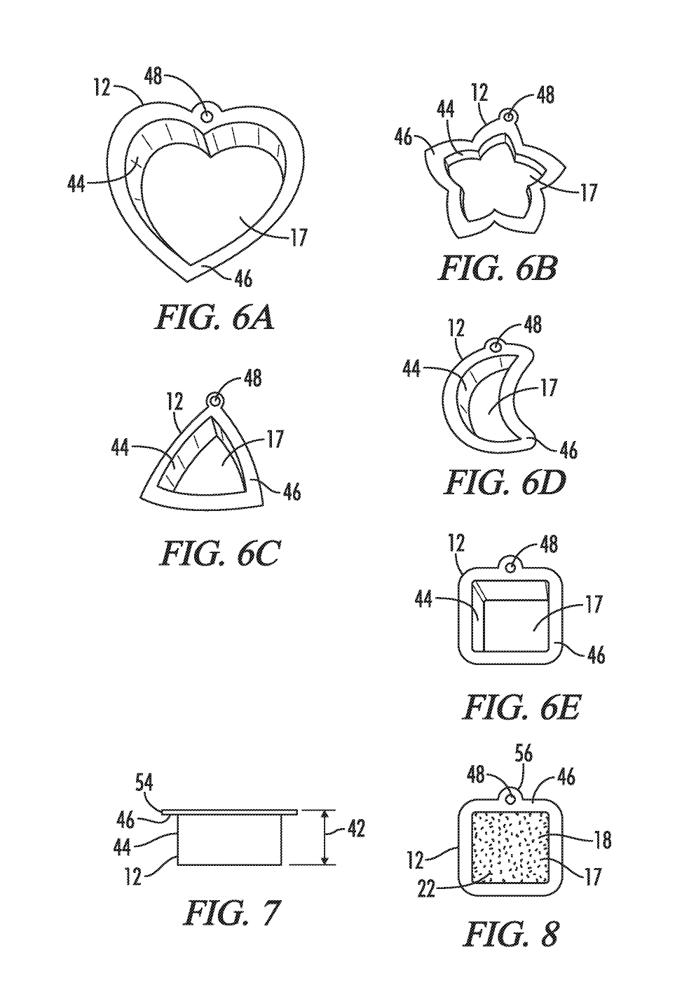

FIG. 8 is a top view of the tub 12 of FIG. 6E. Tub 12 includes aperture 48 disposed in sealing flange 46, which defines tub opening 17. Heat sensitive material 22 may be stored in chamber 18 and dispensed, or poured from, from tub opening 17. Aperture 48 may be in a wing 56 extending from sealing flange 46.

### Methods of Manufacture

In another embodiment, a method of manufacturing container assembly 2 is provided. The method of manufacturing may include providing a main container 4 including an opening 6. The method may include attaching closure 8, also known as cap 8, to main container 4. Closure 8 in main container 4 may include externally open recess 10. Tub 12 may be loosely disposed in recess 10, and secured in recess 10 with packaging 14. Main container 4 may be provided with a liquid nutritional composition 20, and tub 12 may be provided with heat sensitive material 22. Tub 12 may be combined with main container 4 after main container 4 is filled with a heat treated nutritional composition 20. Assembly 2 may be wrapped with removable packaging 14, such as a heat-shrinkable polymer film.

In an embodiment, main container 4 is provided with nutritional composition 20. Main container 4 and nutritional composition 20 may be subjected to heat treatment. Nutritional composition 20 may be heat treated to a temperature of at least 120 degrees C., 140 degrees C., or 160 degrees C. After heat treatment of nutritional composition 20, tub 12 is assembled with the container 4. The tub 12 is provided with heat sensitive material 22. Main container 4 and tub 12 are secured with packaging 14.

To use assembly 2, a user may partially remove packaging 14 such that the user can access tub 12, cap 8, and collar 30. The user may remove tub 12 from assembly 2. The user may then remove cap 8 and peel off main container seal 58. The user can then add the heat sensitive material 22 from the tub 12 into main container chamber 16 to combine the heat sensitive material 22 with the nutritional composition 20. The user may then replace cap 8, mix the combined contents of the chamber 16, and dispense and administer the mixture to a subject, such as an infant.

Advantageously, the present disclosure provides a method of heat treating, heat sealing, and/or sonic sealing nutritional composition 20 or tub 12 while not subjecting the heat sensitive material 22 to heat treatment, as heat sensitive material 22 is at risk of becoming nonfunctional when subjected to heat treatment. Particularly advantageous is that the container assembly 10 provides a convenient, attractive, and easily shippable and storable product for providing separate nutritional composition 20 and heat sensitive material 22. Furthermore, the various tub 12 shapes will provide benefits in salability by creating a desire in users (i.e., consumers) to collect different tub 12 shapes. In furtherance of this, different tub 12 shapes could be released as collectible. Other additional secondary functions of tub 12 may be as a toy, charm, ornament, or stamp for printing, or mold for forming shapes.

Although embodiments of the disclosure have been described using specific terms, devices, and methods, such description is for illustrative purposes only. The words used are words of description rather than of limitation. It is to be understood that changes and variations may be made by those of ordinary skill in the art without departing from the spirit or the scope of the present disclosure, which is set forth in the following claims. In addition, it should be understood that aspects of the various embodiments may be interchanged in whole or in part. Therefore, the spirit and scope of the appended claims should not be limited to the description of the versions contained therein.

Thus, although there have been described particular embodiments of the present invention of a new and useful container, it is not intended that such references be construed as limitations upon the scope of this invention except as set forth in the following claims.

What is claimed is:

1. A container assembly, comprising:
a main container including an opening;
a cap closing the opening;
an externally open recess on the main container or the cap;
a tub disposed at least partially in the recess; and
a removable packaging disposed around the container assembly such that the removable packaging retains the tub in the recess.

2. The container assembly of claim 1, wherein
the main container includes a main container chamber;
the tub includes a tub chamber;
a liquid nutritional composition is received in the main container chamber; and
a heat sensitive material is received in the tub chamber.

3. The container assembly of claim 2, wherein the heat sensitive material comprises lactoferrin, a probiotic or a combination thereof.

4. The container assembly of claim 1, wherein the externally open recess is positioned on a top surface of the cap.

5. The container assembly of claim 4, wherein the recess is defined by a circular sidewall extending around the top surface of the cap.

6. The container assembly of claim 1, wherein the tub includes a tub chamber and a removable closure closing the tub chamber.

7. The container assembly of claim 1, further comprising a collar hingedly connected to the cap, wherein the collar is removably connected to the main container.

8. The container assembly of claim 1, wherein the removable packaging comprises shrink wrap.

9. The container assembly of claim 1, wherein the recess has a solid surface disposed against the tub.

10. A container assembly, comprising:
a main container including an opening;
a cap closing the opening, the cap including a cap sidewall defining an exterior recess; and
a top tub disposed at least partially in the recess.

11. The container assembly of claim 10, wherein the top tub includes a chamber and a tub closure removably sealing the chamber.

12. The container assembly of claim 10, wherein the top tub has an aesthetically pleasing profile.

13. The container assembly of claim 12, wherein the aesthetically pleasing profile is a heart-shaped profile, a circular profile, a star-shaped profile, a triangular profile, a reuleaux triangle-shaped profile, a crescent moon-shaped profile, a rectangular profile, or a square-shaped profile.

14. The container assembly of claim 10, wherein the main container comprises a liquid nutritional composition, and wherein the top tub comprises a heat-sensitive ingredient, a moisture-sensitive ingredient, or an ingredient removed from the liquid nutritional composition to extend shelf life of the liquid nutritional composition, or combinations thereof.

15. The container assembly of claim 10, wherein the cap sidewall has a cap sidewall height and the top tub has a top tub height, and wherein the top tub height is greater than the sidewall height.

16. The container assembly of claim 10, wherein the top tub has a tub sidewall defining an opening, and wherein the tub sidewall includes a sealing flange extending outwardly around the opening.

17. The container assembly of claim 16, wherein the sealing flange includes an aperture.

18. A method of manufacturing a container assembly, comprising:
providing a main container including an opening;
attaching a closure to the main container, wherein the closure or the main container include an externally open recess;
loosely disposing a tub in the recess; and
securing the tub in the recess with packaging.

19. The method of claim 18, further comprising providing the main container with a liquid nutritional composition, and providing the tub with a heat sensitive material.

20. The method of claim 18, wherein the securing step comprises wrapping the tub with a heat-shrinkable polymer film.
